(19) United States
(12) Patent Application Publication
(10) Pub. No.: US 2004/0029600 A1
(43) Pub. Date: Feb. 12, 2004

(54) Cellular radio telecommunication system

(76) Inventors: Nicholas Dougall Johnson, St Albans (GB); Neil Philip Piercy, Royston (GB)

Correspondence Address: Gregory J Lavorgna, Drinker Biddle & Reath, One Logan Square, 18th & Cherry Streets, Philadelphia, PA, 19103-6996, US

(21) Appl. No.: 10/332,936

(22) PCT Filed: Jul. 16, 2001
(86) PCT No.: PCT/GB01/03183

(30) Foreign Application Priority Data
Jul. 14, 2000 (GB) 0017429.2

(51) Int. Cl. H04B 7/00

(52) U.S. Cl. 455/500; 455/560; 455/426.2

(57) ABSTRACT

A cellular radio telecommunication system comprises a plurality of base stations (BS1, BS2, BS3, BS4) and a basestation controller (PC). The basestation controlled is arranged to control the base stations so that at least two of the base stations use the same broadcast control channel, each basestation being substantially synchronised with respect to each other. The basestation controller further controls the base stations to use dedicated traffic and signalling channels within the immediate vicinity of each basestations. The telecommunication system seeks to provided the maximum space diversity gained in traffic capacity by controlling the base stations so that they use a single broadcast synchronise control channel and separately handle dedicated traffic and signalling channels in their immediate vicinity.

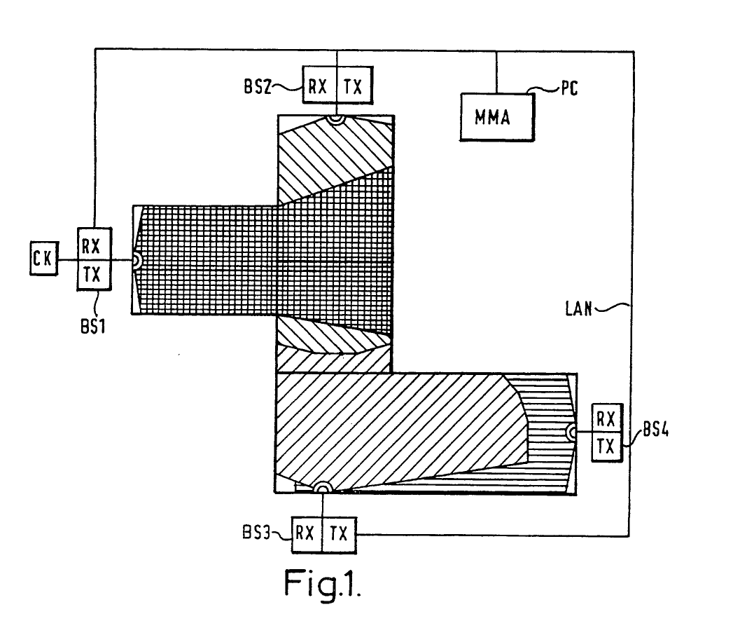

### TECHNICAL FIELD

This invention relates to cellular radio telecommunication systems, and especially private systems and their adaptation to work with public cellular radio telecommunication systems.

Cell planning and frequency reuse within a cellular network become more and more difficult as the traffic density rises and the cell size falls. This is especially so for outdoor base stations covering indoor users, firstly because of reduced propagation loss (from fourth power to square law) with reduced propagation distance, resulting in increased spillover beyond nominal cell boundaries, and because of the insertion loss of walls, ceilings and other obstructions, which require increased power operation from both base stations and mobiles. These two factors increase the so-called “co-channel interference” problem, which is to say, the increase in interference from nearby cells and mobiles operating on the same frequency channels. Channels can only be reused at greater and greater distances. Even with private indoor networks supplying indoor coverage, the extremely small size of the cells (less than 50 m diameter) can result in a demand for channels greater than the public operators can provide.

One possible solution to this problem is to use a repeater, which carries the signal into a building where it is most needed. In this way, the power levels for both mobile and basestation can be kept low, and the co-channel interference problem is reduced. The drawback of using repeaters is that they offer no new capacity; they simply bring existing capacity closer to where it is needed. In commonly accepted scenarios where mobile usage will be moving indoors, this approach will not offer the required channel capacity.

Another approach to the problem is to use a technique called Intelligent Underlay-Overlay (IUO), which reuses spectrum differently, depending on its use. In this technique, GSM beacon frequencies (carrying the so-called Basestation Control Channel or BCCH) are reused in a low density pattern, to ensure low interference between beacons, and an extremely low probability of error on these broadcast channels. Traffic channels are reused in a higher density pattern, to provide high capacity at the expense of some interference. The attraction of this scheme is the high spectral efficiency of the telephony traffic.

Although use of a repeater is a viable option for low capacity indoor coverage to ameliorate the co-channel interference problem, the cost of providing this coverage by repeater technology rises unacceptably as the indoor traffic rises. Other micro-cellular techniques using micro- and pico-basestations may be used such as “distributed antenna” technology; for example, a “leaky feeder”, such as a length of coaxial cable with openings made in its outer screen to allow RF energy in and out of the cable. Losses in the cable, its high cost and generally high installation overhead restrict this technology to short cable runs. Other examples use optical fibre to transport the RF and modulate the RF on and off the fibre at special RF head units. Though suitable for long cable runs, the high cost of the optical fibre and the modulation and demodulation units restricts the applicability of this technology. Yet other examples, distribute the RF at a lower, intermediate frequency (IF), and heterodyne this up to the required band at special RF head units. Since the distribution is done at IF, the cable runs may be long and the cable cheap, but again the requirement for specialised RF head units adds cost to the technique.

### DISCLOSURE OF THE INVENTION

An object of the invention is to provide an improved cellular radio telecommunication system suitable for in-building coverage, compatible with an external public cellular network and existing unmodified mobile terminals.

This is achieved according to the invention by providing a network of base stations and controlling them so that they use a single broadcast synchronised control channel, and separately handle dedicated traffic and signalling channels in their immediate vicinity.

Such a network can achieve the theoretical minimum radio channel consumption, yet provide the maximum space diversity gain in traffic capacity typical of cellular telephony systems.

The invention is particularly applicable to TDMA systems such as GSM systems.

In order that the over-the-air frame structure transmitted (and received) in the coverage area of the network of the invention is time synchronised for all mobile subscriber units, it is necessary to synchronise the base stations to within a few bit periods (each bit period is approximately 4 μs in GSM). It is not required to synchronise the base stations more closely than this (though it may be convenient to do so) since mobile subscriber units are designed to deal with signals arriving with timing differences of this order. For example, GSM mobiles have an equaliser which can detect two signals in a multipath channel, with delay spreads of several bit periods. This contrasts with normal GSM and other cellular networks, in which it is not required that base stations should be synchronised with each other.

The base stations are, like normal GSM base stations, equipped with the ability to receive, process and report uplink signals for mobile units transmitting to them. In addition, they also have the ability to receive, process and report signals when they are idle, in order to sense active transmissions which are being handled by nearby base stations. In the GSM case, the base stations have the ability to receive in unused timeslots, in any arbitrary radio channel within the uplink band. This ability is used according to a further feature of the invention to gather information on the usage of radio channels in the close physical proximity to the basestation on a slot-by-slot basis.

The actual measurement parameters (timeslots, RF channels and measurement schedule in the GSM case) are sent by a controlling agent to each basestation, which then reports its results (signal strength, signal quality and a unique identifier, or RSSI, RXQUAL, burst identifier in the GSM case) to the controlling agent. The burst identifier is a code calculated from the burst to allow it to be compared with other measurements in the controlling agent. For instance it might be an n-bit exclusive-OR operation between adjacent n-bit words of the burst payload, delivering an n-bit identifier. Alternatively it may be an n-bit Forward Error Correction (FEC) code derived from the payload. Bit errors in the burst payload will be concentrated in the burst identifier so calculated. However, at limiting sensitivity, the bit error rate (BER) is 2%, so that for a normal burst (with a payload of 116 bits) just over 2 bits on average will be in error. The burst identifier will therefore have approximately 2 bits in error also. Therefore n is chosen in the n-bit identifier construction so that the probability of misidentifying a burst is acceptably small.

The controlling agent can rank the base stations in order of proximity to a particular mobile station, based on correlating the uplink measurements from all the base stations with the burst identifiers.

The controlling agent can route the signalling and data traffic to one or more of the closest base stations to the mobile unit, according to example algorithms described below. More than one basestation may be used to achieve reinforcement of the signal received by the mobile unit, this being possible because the base stations are all synchronised.

Just as the downlink data may be multiply routed, so uplink data may be multiply received. If there are unused radio resources (timeslots in the GSM case) in nearby base stations, they may be tuned to receive uplink data from a nearby mobile unit. The uplink data so received may be routed to the controlling agent, and combined there, further to reduce the error rate in the data. For example, if the same data is received through more than two basestation receivers, then a simple majority voting algorithm can be used to correct individual bits within the data stream. This feature can be used either to increase the quality of the received data, or the quality of the data can be maintained, and the transmit power of the mobile can be decreased so as to decrease interference with any external network.

As the mobile unit moves through the network, the controlling agent can change the routing of the signalling and data traffic, to maintain the connection with the mobile unit, to maximise the traffic throughput of the network, and to minimise interference with the external network, again according to example algorithms described below.

Thus, in contrast with a conventional GSM network system, the mobile subscriber unit is not responsible for signal measurements to identify neighbouring base stations for use in controlling handover, but instead it cannot distinguish between base stations and it is the responsibility of the base stations and controlling agent to track each mobile through the system.

In the foregoing discussion, the term “channel” may mean a static frequency channel, or a hopping channel with defined hop frequencies and hop sequence.

Preferably, the controlling agent processes the proximity measurements signals over a period of time to build up a control algorithm, which may take the form of a “neighbourliness” matrix linking each basestation with each of its neighbours in a ranked manner.

The proximity measurement signals may comprise received quality and level measurements at the base stations, and at the mobile subscriber unit, and these measurements may be made in relation to channel request signals or other signalling or traffic signals transmitted by the mobile subscriber unit. These measurements may involve measurement of the carrier-to-interference C/I ratios.

In an alternative embodiment of the invention, soft decision values and a soft decision sum generated at the basestations in decoding received signals such as channel request bursts are used as proximity values in place of or as well as the level or quality measurements of channel request bursts as described above.

The soft decision sum is calculated in the equaliser in the basestation, and it is calculated before the other quality values—RXQUAL or C/I. In the demodulation process, each bit of the burst is digitised to lie in a range (which is typically, though not necessarily {0 . . . 7} inclusive). In this range, in the example given, the value 0 indicates the most confident binary ‘0’, and the value 7, the most confident binary ‘1’. Intermediate values indicate binary 0 to 7, with varying confidence, so that the value 1 is likely to indicate binary ‘0’, but with less confidence than value 0, value 2 indicates ‘0’, but with less confidence than 1, value 6 indicates ‘1’, but with less confidence than value 7, and so on. This technique is well known in the art, and equalisers employing this technique are known as soft-decision equalisers. When coupled with decoders (such as the well-known Vitetbi decoder) that can make use of the soft-decision values, such equalisers offer superior performance to hard-decision equalisers, where the demodulated bits are unequivocally assigned binary ‘0’ or ‘1’. If the soft-decision value is complemented, based on the value of the most significant bit (MSB), so that all values with a ‘0’ MSB are complemented, and all values with a ‘1’ MSB are not complemented, and then the MSB is removed from the value, then a set of values is derived (for example range {0 . . . 7} given) of {3, 2, 1, 0, 0, 1, 2, 3}. The properties of this set are clear—high values correspond to high levels of confidence in the assigned bit value. If these values are added for every bit in the burst, then a value is obtained called here, the soft-decision sum. The use of this soft-decision sum is attractive in this application since it can be related to signal strength and quality as a single parameter. It therefore folds real-world handover success factors into the statistics captured in the neighbourliness matrix or other control algorithm described below. For instance, handovers into strongly interfered channels are likely to fail, just as they are into channels where the neighbour signal is weak. The calculation of the parameter adds little overhead to the normal operation of the soft-decision equaliser. In the context of the invention, a high soft-decision sum signifies close proximity, and a low values indicate low proximity.

Alternatively, or additionally, the proximity measurements (by any of the methods described above) may be collected by the basestations, by operating on the normal traffic and signalling bursts transmitted by a test mobile in a call as it is moved through the ensemble of basestations.

Alternatively, or additionally, the proximity measurements (by any of the methods described above) may be collected by a test mobile, by operating on the beacon channel signals transmitted by all the basestations as the test mobile is moved through the ensemble of basestations.

The latter two alternative or additional methods using a test mobile may be convenient methods to initialise a “neighbourlines s” matrix, or to set it up for static use, though this is generally not preferred. Best use is made of the neighbourliness matrix from its dynamic properties, as described below.

Some of the base stations broadcast a basestation control channel on a predetermined beacon frequency so that a mobile subscriber unit anywhere within the radio coverage of the system will receive the same control data. However, those base stations not broadcasting the basestation control channel are free to operate at frequencies other than the beacon frequency, and thus serve to provide increased traffic capacity.

When the system of the invention is considered in the context of an external macro cellular radio network, with which it is to be compatible, then said predetermined beacon frequency must be selected to minimise interference with the external network. However, the frequencies used for the traffic channels can be planned separately, for example, using an IUO scheme. The beacon frequency can be transmitted at a lower power because it is transmitted by multiple base stations within the system, and thus interference with the external macro network is reduced.

It will be appreciated that a mobile subscriber unit moving within the network of base stations will receive time-delayed copies of the control data from each basestation, but that the equaliser within the mobile subscriber unit will treat these as multi-path copies and reconstruct them in the usual manner. The mobile subscriber unit will therefore see the network of base stations as a single cell.

### DESCRIPTION OF THE DRAWING

The invention will now be described by way of example with reference to the accompanying schematic drawings of a cellular radio telecommunication system according to the invention as applied to an in-building network.

### BEST MODE OF CARRYING OUT THE INVENTION

Consider the in-building network shown in the drawing. In this example, each basestation BS contains one transceiver (TX/RX). All the base stations are synchronised according to the invention. The network is configured so that a small number of base stations transmit the GSM beacon, so as to cover the whole area of interest at reasonably low power. In this example, we configure BS1 and BS3 to transmit a synchronised beacon. BS2 and BS4 are therefore free to be used according to the invention for the provision of additional traffic capacity, and radio channel measurement, as required.

If this deployment of base stations were configured as a conventional GSM network, then each basestation would have to broadcast its beacon on a separate channel. The frequency re-use properties of this network in this traditional implementation are problematic, since the BCCHs frequencies must be re-used on a low density pattern to prevent interference, and probably even lower density than for the macro-network, owing to the square law drop-off in power from each basestation. The channel requirements of this in-building network are uncomfortably large, and the interference problems induced by such a network on the external macro network may be unacceptable.

In the illustrated example, four separate BCCH channels would be needed, one for each basestation BS, with normally a guard channel between each one, therefore the system requires 9 RF channels in total. Even though the base stations would be operating at low power, macro network base stations near the building would have to avoid these frequencies to ensure good reception for mobiles in the vicinity. Even in this extremely small example therefore, nearly 15% of the operator's allocation of say 60 channels is devoted to this one installation (assuming two operators in the band).

If, however, all the base stations are synchronised together according to the invention, and broadcast the same BCCH information and each beacon channel is tuned to the same RF channel, then the network will consume only one RF channel for BCCH in the whole in-building network. Mobiles moving within the network will simply receive time-delayed copies of the BCCH information from each basestation, and the mobile equalisers will treat them as multi-path copies, and reconstruct them as normal.

Such a network, is similar to a repeater network. It provides good coverage at minimum interference, but only 7 channels of traffic capacity for the whole network. In order to increase its traffic capacity extra transceivers (TX, RX pairs) (BS2 and BS4 in the drawing) are added at some or all of the base stations, and a controller PC is provided according to the invention which is connected to the base stations via a packet-switched local area network LAN to direct traffic by the “least interference” route through the network, the controller incorporating a “mobility management agent” MMA, which gives it this functionality.

The basic function of the MMA is to route the maximum amount of traffic (seen as an ensemble) via channels of acceptable quality determined according to C/I ratios measured at mobile and basestation within the network. It is also a requirement of the network as a whole that it interferes by the least possible amount with the macro network lying beyond its boundaries. This requirement is met by selecting a routing algorithm that minimises the power transmitted by both mobile and basestation for the duration of the call. The algorithms by which we achieve this are described below.

One of the key properties of the network which differentiates it from a repeater network, is that even though the network appears to be a single cell from the point of view of the mobile (and the macro network), it is possible to assign a traffic channel to a single basestation within the network, and for all other base stations to remain unaffected.

For all mobiles in idle mode, the network has no idea where the mobile is, or which basestation is nearest. However, as soon as a mobile makes a channel request (via the random access channel RACH), each basestation can report received level RXLEV and received quality RXQUAL for the RACH burst, and the MMA can select the route of the access grant channel AGCH. Note that since the network is synchronised, the AGCH (and any other channel for that matter) may be sent through any available basestation. Moreover it may be sent through more than one basestation to ensure that the target C/I ratio at the mobile is achieved.

As the mobile moves through the network it is the responsibility of the MMA to direct base stations (both serving and non-serving) to make uplink RXQUAL and RXLEV measurements continuously to help track each mobile through the network. The MMA will automatically build and maintain a “neighbourliness” matrix linking each basestation in a ranked way, based on uplink measurements made by each of the base stations as traffic builds. Immediately after first switch on, the neighbourliness matrix will be null. On first assignment request by a mobile subscriber unit, each basestation will report the received strength and quality of the RACH burst, and these will be reported to the MMA. The MMA may combine the two measurements and update the neighbourliness matrix with them, or alternatively, it may keep two matrices, one for signal strength, which corresponds to the static physical disposition of the basestation and their surroundings, and one for quality, which corresponds to the instantaneous interference properties of the network.

There are many possible routing algorithms that may be used by the MMA to route call and data traffic through the network. The simplest one may be a nearest neighbour routing, where traffic data are routed through a single basestation with the best RF visibility of the mobile terminal. In order to make best use of possibly unused radio capacity within the local network, and to minimise interference with any exterior network, a minimum power routing algorithm may be used. In this method, downlink interference is minimised by routing the downlink traffic data through several base stations, and the downlink power level of each basestation is controlled by commands from the MMA, so that the target C/I ratio and minimum receive power criteria are achieved at the mobile terminal. By this method the theoretical minimum downlink interference level for any given basestation deployment is achieved. Uplink interference is minimised by nearest neighbour routing of the uplink traffic, and by commanding the mobile to transmit at the minimum power level so as to achieve the target receive signal quality and strength at the basestation receiver. In a busy network, the spare capacity required for minimum power routing may not be available, and so the method reduces to nearest neighbour routing.

There are many possible algorithms for estimating the neighbourliness of base stations one to another. One example algorithm is described here, with reference to access bursts received by an inbuilding network of GSM base stations.

Whenever a mobile station requests a dedicated channel, it sends an access burst on its RACH channel, which is always timeslot zero of the C0 channel. If the measurement made of the k^{th} access burst, by the i^{th} basestation is mᵢ, then for each burst k, there is a set of measurements

{mᵢ}

These measurements are processed in order to update the neighbourliness matrix. An important prefilter is based on the maximum power observed in the network. If the power is above a certain threshold, then the burst originates nearby, and the measurement set has meaning.

Having established that the RACH burst originates within the physical coverage area of the network, then the measurements are used to estimate which base stations are nearest to each other.

$$Ci , j = {\sum }_{k} ( {P}_{i} , {P}_{j} )$$

Where Pᵢ is the generalised proximity measurement made on the k^{th} burst at basestation i.

In this example, the measured burst is access burst, but while this restriction is a convenient one for implementation, measurements can be made on any single burst that is identifiable at the respective basestations as originating from a single mobile the sum is taken over values of k where the signal level at any one basestation i is above a certain threshold.

This matrix captures the probability that two base stations i and j are in close RF proximity. Cij will only be large if both Pᵢ and Pⱼ are large, which will be true only if both base stations i and j are close to the origin of the burst, and therefore to each other. The MMA preferably ages the measurements over which it calculates C and discards the oldest as newer ones are made. This helps to keep track of changes in the physical layout and interference environment of the network, and secondly it aids normalisation to keep the calculation set over a limited number of measurements.

The neighbourliness matrix is maintained by keeping timeslot zero of all base stations as unoccupied as possible. In this way, as many transceivers in the network as possible are able to tune to C0 for timeslot zero and make uplink measurements on any RACHs transmitted during the operation of the network.

The objective of the neighbourliness matrix is to give an a posteriori likelihood measure for the “neighbourliness” of base stations. By basing this on an average measure made on particular bursts transmitted by particular mobiles, a matrix will eventually be built based on real traffic from real mobiles moving through the network on real physical paths. The matrix in effect incorporates the probabilities of successful handovers between basestations. This is particularly directed at supporting internal handover between base stations where there are no helpful measurement the mobile can make.

As handover approaches, as detected by power budget, uplink quality or signal strength, or downlink quality or signal strength, the MMA uses the neighbourliness matrix to determine a new route for the traffic. If the currently serving base station is i, then it sorts the i^{th} column of C, to generate an ordered list of possible neighbour base stations. The first entry in the list should correspond to the most likely neighbour, the second should be the next most likely and so on. It then attempts to find free resources (timeslots in the GSM case) in the candidate neighbour, and having found them, will re-route the traffic to the new neighbour, reassigning the timeslot/hop parameters (intra-cell handover) if necessary. If no resources are free, then the search continues down the list until either free resources are found, a minimum value of neighbourliness is crossed, or the list is exhausted.

When the system is not busy, it may be possible for the MMA to operate without the neighbourliness matrix, and instead simply rely on the latest {mᵢ} set of measurements from the mobile to choose the best new route, using the nearest neighbour algorithm.

While all the beacon frequencies in the network are set to the same value, which is selected to minimise interference with the macro network, the frequencies to be used by traffic channels in the base stations are planned separately using a conventional IOU scheme.

An important requirement of the network is to synchronise all of the base station to the same GSM timebase. This can be achieved by many methods, for instance providing a single synchronisation signal along with the LAN data connection to each of the base stations.

1. A cellular radio telecommunication system comprising a plurality of base stations and a basestation controller arranged to control said base stations so that at least two base stations use the same broadcast control channel, each basestation being substantially synchronised with respect to each other, the basestation controller further controlling said base stations to use dedicated traffic and signalling channels within the immediate vicinity of each basestation.

2. A cellular radio telecommunication system according to claim 1, wherein each basestation may receive, process and report to the basestation controller, signals transmitted from a mobile station to one or more of the other base stations.

3. A cellular radio telecommunication system according to claim 2, wherein said transmitted signals may be received in any channel within the transmission band.

4. A cellular radio telecommunication system according to claim 2 or 3, wherein at least one proximity measurement parameter is transmitted by the basestation controller to said base stations and each basestation performs a proximity measurement of said parameter on the signals transmitted from said mobile station and reports the results of the measurement to the basestation controller.

5. A cellular radio telecommunication system according to claim 4, wherein said proximity measurement parameter may be received signal strength or received signal quality.

6. A cellular radio telecommunication system according to claim 4 or 5, wherein said proximity measurement parameter is the carrier-to-interference ratio.

7. A cellular radio telecommunication system according to any of claim 4 in which said proximity measurements are based on soft decision values from the basestations.

8. A cellular radio telecommunication system according to any one of claims 4 to 7, wherein the proximity measurements may be made in response to channel request signals transmitted by the mobile station.

9. A cellular radio telecommunication system according to any one of claims 4 to 7 wherein the proximity measurements are made in response to normal signalling or traffic signals transmitted by the mobile station.

10. A cellular radio telecommunication system according to any one of claims 4 to 9, wherein each basestation calculates an identification code from the signal transmitted by said mobile station, the identification code providing an unique identification of said mobile station, and sending said identification code with said measured proximity parameters.

11. A cellular radio telecommunication system according to claim 10, wherein the basestation controller ranks the base stations in order of proximity to said mobile station.

12. A cellular radio telecommunication system according to anyone of claims 2 to 11, wherein the basestation controller selects the output of one or more of the closest base stations to receive signals from the mobile station.

13. A cellular radio telecommunication system according to claim 11, wherein the basestation controller selects at least three of the closest base stations to receive said signals from the mobile station.

14. A cellular radio telecommunication system according to claim 13, wherein the basestation controller applies a majority voting scheme to the signals received at said closest base stations to correct errors within the received signals.

15. A cellular radio telecommunication system according to claim 12 or 13, wherein the transmission power of the mobile station is reduced.

16. A cellular radio telecommunication system according to any one of claims 4 to 15, wherein said basestation controller processes said proximity measurement signals over a period of time to build up a control algorithm.

17. A cellular radio telecommunication system according to claim 16, wherein said control algorithm takes the form of a matrix linking each basestation with each of its neighbours in a ranked manner.

18. A cellular radio telecommunications system according to claim 17, wherein said matrix contains the probabilities of success for handovers between respective base stations.

19. A cellular radio telecommunications system according to claim 18, wherein said probabilities are calculated by correlating the proximity measurements made during the operation of the network between base stations for signals transmitted by individual mobiles.

20. A cellular radio telecommunications system according to any one of claims 18, wherein said probabilities are measured, by correlating the signal strengths of base stations as measured by a test mobile within the network.

21. A cellular radio telecommunication system according to any one of claims 17 to 20 wherein said matrix comprises proximity measurement values corresponding to the probability of a mobile being in the vicinity of two base stations.

22. A cellular radio telecommunication system according to any one of claims 14 to 21, wherein a predetermined number of proximity measurement signals are processed to build said control algorithm.

23. A cellular radio telecommunication system according to claim 22, wherein the oldest proximity measurement signals are discarded if the total number of proximity measurement exceeds said predetermined number.

24. A cellular radio telecommunication system according to any preceding claim, wherein said cellular radio telecommunication system utilises Time Division Multiple Access.

25. A cellular radio telecommunication system according to claim 24, wherein said traffic and signalling channels are allocated according to an Intelligent Underlay-Overlay scheme.

26. A cellular radio telecommunication system according to claim 22 or 23, wherein said cellular radio telecommunication system is a GSM system.
